(19) United States
(12) Patent Application Publication
(10) Pub. No.: US 2026/0172412 A1
(43) Pub. Date: Jun. 18, 2026

(54) METHOD, APPARATUS, DEVICE, AND STORAGE MEDIUM OF REQUEST PROCESSING

(71) Applicant: Douyin Vision Co., Ltd., Beijing (CN)

(72) Inventors: Xi CHEN, Beijing (CN); Boyang LIU, Beijing (CN)

(21) Appl. No.: 19/121,372

(22) PCT Filed: Jun. 26, 2024
(86) PCT No.: PCT/CN2024/101744

§ 371 Date: Apr. 15, 2025

(51) Int. Cl. H04L 9/40

(52) U.S. Cl. CPC H04L 63/0815

(57) ABSTRACT

According to embodiments of the disclosure, a method, apparatus, device, and a storage medium of request processing are provided. The method includes: in response to a request to call a second workload by a first workload, receiving a first identity token associated with the first workload, the first workload being associated with a first trust domain, the first identity token being generated based on a first authentication protocol corresponding to the first trust domain, and the second workload being associated with a second trust domain; generating a second identity token corresponding to a second authentication protocol based on identity assertion information indicated by the first identity token, the second authentication protocol corresponding to the second trust domain; and sending the second identity token to the first workload, to enable the first workload to call the second workload based on the second identity token.

### CROSS-REFERENCE

This application is a National Stage of International Application No. PCT/CN2024/101744, filed on Jun. 26, 2024, entitled “METHOD, APPARATUS, DEVICE, AND STORAGE MEDIUM OF REQUEST PROCESSING”, which is hereby incorporated by reference in its entirety.

### FIELD

Example embodiments of the present disclosure generally relate to the field of computers, and more particularly, to a method, apparatus, device, and a computer-readable storage medium of request processing.

### BACKGROUND

In modern cloud computing and microservice architecture, workloads are often distributed in trust domains, and the authentication protocol corresponding to the trust domain where the workloads reside can generate identity tokens corresponding to the workload. Different workloads may be distributed in different trust domains, and their corresponding work tokens may be generated by different authentication protocols. How to call and access between two workloads distributed in different trust domains, where identity tokens are generated based on different authentication protocols, is a focus of attention.

### SUMMARY

In a first aspect of the present disclosure, a method of request processing is provided. The method includes: in response to a request to call a second workload by a first workload, receiving a first identity token associated with the first workload, the first workload being associated with a first trust domain, the first identity token being generated based on a first authentication protocol corresponding to the first trust domain, and the second workload being associated with a second trust domain; generating, based on identity assertion information indicated by the first identity token, a second identity token corresponding to a second authentication protocol, the second authentication protocol corresponding to the second trust domain; and sending the second identity token to the first workload, to enable the first workload to call the second workload based on the second identity token.

In a second aspect of the present disclosure, an apparatus for request processing is provided. The apparatus includes: a receiving module configured to receive, in response to a request to call a second workload by a first workload, a first identity token associated with the first workload, the first workload being associated with a first trust domain, the first identity token being generated based on a first authentication protocol corresponding to the first trust domain, and the second workload being associated with a second trust domain; a generating module configured to generate a second identity token corresponding to a second authentication protocol based on identity assertion information indicated by the first identity token, wherein the second authentication protocol corresponds to the second trust domain; and a sending module configured to send the second identity token to the first workload, to enable the first workload to call the second workload based on the second identity token.

In a third aspect of the present disclosure, an electronic device is provided. The device includes at least one processor; and at least one memory coupled to the at least one processor and storing instructions for execution by the at least one processor. When the instructions are executed by the at least one processor, the device is caused to perform the method in the first aspect.

In a fourth aspect of the present disclosure, a computer-readable storage medium is provided, in which a computer program is stored in the computer-readable storage medium, and the computer program can be executed by a processor to implement the method in the first aspect.

In a fifth aspect of the present disclosure, a computer program product is provided, which includes computer executable instructions, and when the computer executable instructions are executed by a processor, the method in the first aspect is implemented.

It should be understood that the contents described in this content section are not intended to limit the key features or important features of the embodiments of the present disclosure, nor are they intended to limit the scope of the present disclosure. Other features of the present disclosure will become easily understood through the following description.

### BRIEF DESCRIPTION OF THE DRAWINGS

The embodiments of the present disclosure will become more apparent with reference to the following detailed description in conjunction with the accompanying drawings. In the accompanying drawings, the same or similar reference numerals represent the same or similar elements, wherein:

FIG. 1 is a schematic diagram showing an example environment in which embodiments of the present disclosure can be implemented;

FIG. 2 is a flow chart showing a request processing process according to some embodiments of the present disclosure;

FIG. 3 shows a flow chart of a request calling process according to some embodiments of the present disclosure;

FIG. 4 shows a schematic structural block diagram of an apparatus for request processing according to certain embodiments of the present disclosure; and

FIG. 5 shows a block diagram of an electronic device capable of implementing various embodiments of the present disclosure.

### DETAILED DESCRIPTION

Embodiments of the present disclosure will be described in more detail below with reference to the accompanying drawings. Although certain embodiments of the present disclosure are shown in the accompanying drawings, it should be understood that the present disclosure can be implemented in various forms and should not be construed as being limited to the embodiments set forth herein. On the contrary, these embodiments are provided to provide a more thorough and complete understanding of the present disclosure. It should be understood that the drawings and embodiments of the present disclosure are only for exemplary purposes and are not intended to limit the scope of protection of the present disclosure.

It should be noted that the titles of any sections/subsections provided herein are not restrictive. Various embodiments are described throughout this article, and any type of embodiment may be included under any section/subsection. In addition, the embodiments described in any section/subsection may be combined in any manner with any other embodiments described in the same section/subsection and/or different sections/subsections.

In the description of the embodiments of the present disclosure, the term “including” and similar terms should be understood as open inclusion, that is, “including but not limited to”. The term “based on” should be understood as “based at least in part on”. The term “an embodiment” or “the embodiment” should be understood as “at least one embodiment”. The term “some embodiments” should be understood as “at least some embodiments”. Other explicit and implicit definitions may be included below. The terms “first”, “second”, etc. may refer to different or the same objects. Other explicit and implicit definitions may be included below.

The embodiments of the present disclosure may involve user data, data acquisition and/or use, etc. These aspects are subject to the corresponding laws, regulations and relevant provisions. In the embodiments of the present disclosure, all data collection, acquisition, processing, furnishing, forwarding, use, etc. are carried out on the premise that the user knows and confirms. Accordingly, when implementing each embodiment of the present disclosure, the type, scope of use, usage scenario, etc. of the data or information that may be involved should be informed to the user and the user's authorization should be obtained in an appropriate manner in accordance with the relevant laws and regulations. The specific notification and/or authorization method can vary according to the actual situation and application scenario, and the scope of the present disclosure is not limited in this respect.

If the solutions in this specification and the embodiments involve the processing of personal information, they will be processed on the premise of having a legal basis (such as acquiring the consent of the subject of personal information, or being necessary for the performance of a contract, etc.), and will only be processed within the scope of regulations or agreements. If a user refuses to process personal information other than the necessary information for basic functions, it will not affect the user's use of basic functions.

An embodiment of the present disclosure proposes a request processing scheme. According to the scheme, in response to a request to call a second workload by a first workload, a first identity token associated with the first workload is received, in which the first workload is associated with a first trust domain, the first identity token is generated based on a first authentication protocol corresponding to the first trust domain, and the second workload is associated with a second trust domain; based on identity assertion information indicated by the first identity token, a second identity token corresponding to a second authentication protocol is generated, in which the second authentication protocol corresponds to the second trust domain; and the second identity token is sent to the first workload, to enable the first workload to call the second workload based on the second identity token.

In the embodiments of the present disclosure, a first identity token generated based on a first authentication protocol can be converted into a second identity token that is trusted by a second trust domain, so as to support a first workload in the first trust domain to call a second workload in the second trust domain based on the second identity token. In this way, the embodiments of the present disclosure can implement cross-protocol identity authentication, thereby supporting request calls across trust domains.

### Example Environment

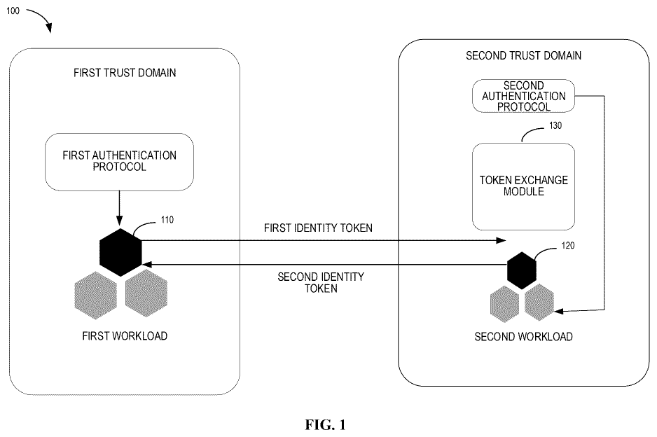

FIG. 1 shows a schematic diagram of an example environment 100 in which embodiments of the present disclosure can be implemented. As shown in FIG. 1, the example environment 100 may include a first workload 110, a second workload 120, and a token exchange module 130.

In the example environment 100, the first workload 110 is associated with a first trust domain, and the second workload 120 is associated with a second trust domain. That is, the first workload 110 is distributed in the first trust domain, and the second workload 120 is distributed in the second trust domain. A trust domain represents a set of entities or systems that trust each other in a specific context, and the entities or systems may include workloads. A workload may be a specific application service or system component.

In some embodiments, a first authentication protocol corresponds to the first trust domain, and a second authentication protocol corresponds to the second trust domain. That is, the workload distributed in the first trust domain generates an identity token based on the first authentication protocol, and the workload distributed in the second trust domain generates an identity token based on the second authentication protocol. In some embodiments, the first workload 110 in the first trust domain generates a first identity token based on the first authentication protocol, and the second workload 120 in the second trust domain generates a second identity token based on the second authentication protocol. The identity token, which can also be referred to as a workload identity, is a unique identifier assigned to a workload in a distributed system. In many modern microservice architectures and cloud environments, workload identities take over the role played by system accounts or service accounts in traditional environments, and they integrate multiple advantages such as providing security, automation, and traceability.

In some embodiments, the token exchange module 130 is associated with the second trust domain, in which the token exchange module 130 is configured to provide a token exchange service. Specifically, after receiving the first identity token sent by the first workload 110, the token exchange module 130 can convert the first identity token into the second identity token with the same identity validity in the second trust domain, so that the first workload 110 can subsequently call the second workload 120 based on the second identity token.

In some embodiments, the token exchange module 130 is a workload with high authority running in the second trust domain, which can autonomously issue identity assertion information authorized within the second trust domain, and can safely store its own identity assertion information. The token exchange module 130 has a secure credential hosting capability, including but not limited to using the following technologies for identity credential protection: hardware security module (HSM), trusted execution environment (TEE), etc.

It should be noted that the structures and functions of various elements in the environment 100 are described for exemplary purposes only and do not imply any limitation on the scope of the present disclosure.

Some example embodiments of the present disclosure will be described below with continued reference to the accompanying drawings.

### Example Process

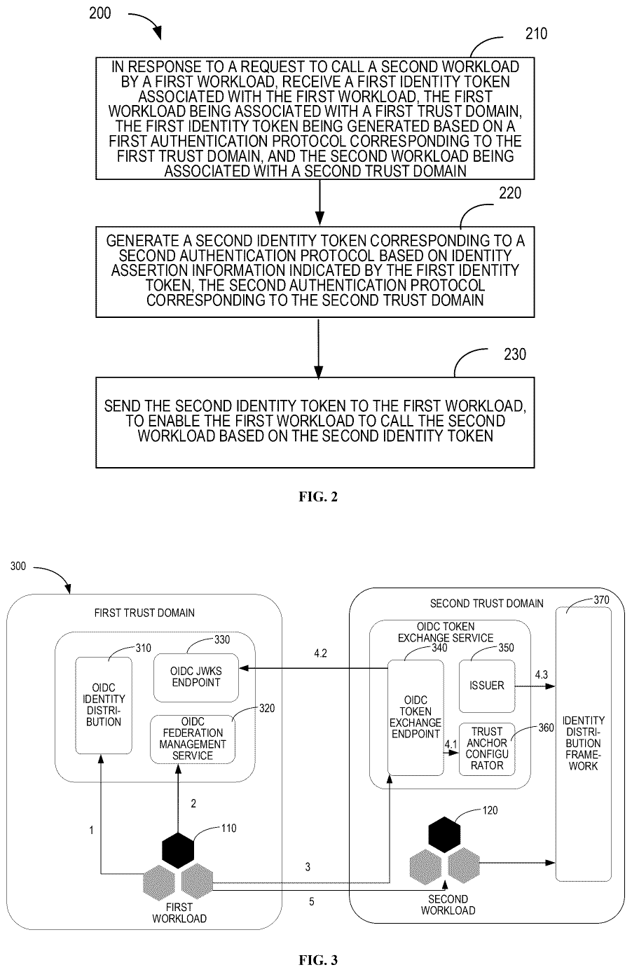

FIG. 2 shows a flow chart of a request processing process 200 according to some embodiments of the present disclosure. The process 200 may be implemented at the token exchange module 130. The process 200 is described below with reference to FIG. 1.

At block 210, the token exchange module 130 receives a first identity token associated with a first workload in response to a request to call a second workload by the first workload, the first workload is associated with a first trust domain, the first identity token is generated based on a first authentication protocol corresponding to the first trust domain, and the second workload is associated with a second trust domain.

In some embodiments, the request to call the second workload by the first workload may be any appropriate type of request, such as a data retrieval request, a data query request, a permission authentication request, etc., which will not be elaborated here.

In some embodiments, the first trust domain and the second trust domain are different trust domains, and the first authentication protocol corresponding to the first trust domain is different from the authentication protocol (second authentication protocol) corresponding to the second trust domain. The first authentication protocol and the second authentication protocol can be any appropriate type of protocol.

As an example, the first authentication protocol is implemented based on an open authorization (OAuth) protocol. The second authentication protocol can be a Secure production Identity Framework For Everyone (SPIFFE), an implementation based on SPIFFE protocol extensions, such as ISTIO, Consul Connect, Linkerd, etc. As an example, the first authentication protocol can be an identity authentication protocol (OpenID Connect, OIDC) based on the OAuth2.0 protocol, and the second authentication protocol can be SPIFFE. It should be understood that such a specific authentication protocol is intended to be used as an example, and the solution of the present disclosure can also be applied to other appropriate authentication protocols.

In some embodiments, the first trust domain is associated with an application development platform, and the first workload is associated with an application developed in the application development platform. In some embodiments, the application development platform may be any suitable platform that provides a set of tools, services, and workflows to help users quickly build, test, and deploy applications. As an example, the application development platform may be an agent development platform, etc., and the first workload may be an agent.

In some embodiments, the second trust domain may also be associated with any appropriate target platform, and the second workload may be associated with a target application developed in the target platform. The target application may be any appropriate application, such as a video application, a music application, a novel application, etc., which will not be described in detail here.

In some embodiments, the first identity token may be any appropriate type of token, such as an ID token, which is a secure JSON token (JSON Web Token, JWT).

In some embodiments, since the first identity token is generated based on the first authentication protocol, it cannot be recognized by the workload in the second trust domain. Therefore, the first workload cannot access the second workload distributed in the second trust domain directly based on the first identity token generated by the first protocol.

In order to ensure that the first workload can call and access the second workload, in some embodiments, the token exchange module 130 can receive the first identity token associated with the first workload via a token exchange endpoint associated with the first trust domain. The token exchange endpoint is a Uniform Resource Locator (URL) and is configured to provide the capability of exchanging identity tokens. That is, the token exchange module 130 can receive the first identity token sent by the first workload in the first trust domain based on this endpoint, and send a second identity token identifiable in the second trust domain, in which the second identity token is generated by the token exchange module 130 based on the first identity token.

In some embodiments, the first workload may obtain first address information of the token exchange endpoint from an identity management service associated with the first trust domain. The identity management service is configured to maintain address information of token exchange endpoints corresponding to other trusted trust domains other than the first trust domain. The first workload may send the first identity token to the token exchange endpoint corresponding to the first address information based on the first address information, to enable the token exchange module 130 to receive the first identity token via the token exchange endpoint.

At block 220, the token exchange module 130 generates a second identity token corresponding to a second authentication protocol based on identity assertion information indicated by the first identity token, in which the second authentication protocol corresponds to the second trust domain.

In some embodiments, the first identity token may include multiple identity assertion fields and field values corresponding to the multiple identity assertion fields. That is, the first identity token may include identity information in the form of key-value, in which the key corresponds to the identity assertion field, and the value corresponds to the field value corresponding to the identity assertion field. In some embodiments, the multiple identity assertion fields may describe the identity information corresponding to the first identity token from different perspectives.

In some embodiments, the token exchange module 130 may determine a target field for identity assertion based on the first identity token. The target field may be at least one field among the multiple identity assertion fields included in the first identity token.

In some embodiments, the token exchange module 130 may determine whether the target field matches an identity authentication field maintained by the second trust domain to authenticate whether the first identity token is trusted.

The identity authentication field maintained by the second trust domain may be a predetermined identity assertion field.

For example, taking the first identity token corresponding to the first workload as including field a, field b, and field c, if the identity authentication field maintained by the second trust domain includes field b and field c, the token exchange module 130 can determine that the target field (field b and field c in the first identity token) matches the identity authentication field (field b and field c) maintained by the second trust domain. If the identity authentication field maintained by the second trust domain includes field b and field d, since the first identity token does not include a field that matches field d maintained by the second trust domain, the token exchange module 130 can determine that the target field does not match the identity authentication field maintained by the second trust domain.

In some embodiments, the token exchange module 130 can generate the second identity token corresponding to the second authentication protocol based on the identity assertion information in response to the target field matching the identity authentication field. That is, the token exchange module 130 can generate the second identity token corresponding to the second authentication protocol based on the identity assertion information of the first identity token after determining that the first identity token is trusted. In some embodiments, the token exchange module 130 can generate the second identity token corresponding to the second authentication protocol based on a field value corresponding to a target identity assertion field in the first identity token. The target identity assertion field and the target field may be the same or may not be exactly the same, which is not described here.

In some embodiments, the token exchange module 130 may determine that the first identity token is not trusted in response to the target field not matching the identity authentication field.

In order to improve data security, in some embodiments, the first identity token may be an identity token encrypted based on a predetermined encryption algorithm. The predetermined encryption algorithm may be any appropriate symmetric encryption algorithm, asymmetric encryption algorithm, etc. As an example, the first identity token may be an identity token encrypted based on a target private key.

In order to decrypt the first identity token, in some embodiments, the token exchange module 130 may obtain a target key corresponding to the first trust domain, in which the target key is associated with the target private key. In some embodiments, the token exchange module 130 may determine second address information of a key obtaining endpoint associated with the first trust domain based on configuration information associated with the second trust domain. The second address information may be an address of any appropriate type, such as a domain name, etc. The token exchange module 130 may obtain the target key corresponding to the first trust domain from the key obtaining endpoint based on the second address information.

In some embodiments, the token exchange module 130 may decrypt the first identity token with the target key to determine the identity assertion information.

In order to improve security, in other embodiments, the token exchange module 130 can obtain a certificate chain issued by the key obtaining endpoint, in which the certificate chain includes at least one certificate other than a root certificate. The certificate chain is issued by a Certificate Authority (CA). In some embodiments, the token exchange module 130 can determine the root certificate based on the configuration information associated with the second trust domain. The root certificate is configured to authenticate the integrity and validity of the certificate chain. In some embodiments, the token exchange module 130 can authenticate the certificate chain based on the root certificate to determine whether the authentication of the target key is passed. If the authentication of the target key is passed, the target key is a secure key. If the authentication of the target key is failed, the target key is not a secure key. In some embodiments, the token exchange module 130 can authenticate the last certificate in the certificate chain based on the root certificate. In response to the authentication of the target key being passed, the token exchange module 130 can decrypt the first identity token based on the target key.

For example, in the certificate chain, certificate a is signed by certificate b, certificate b is signed by certificate c, and certificate c is signed by certificate d. Then certificate d is the last certificate in the certificate chain. In this case, the token exchange module 130 only needs to authenticate certificate d based on the root certificate f. If certificate d is valid, it can be determined that the entire certificate chain is secure, and then the target key is also secure.

In some embodiments, the token exchange module 130 can process the identity assertion information by calling an identity issuance interface corresponding to the second authentication protocol to generate the second identity token corresponding to the second authentication protocol. The second identity token can be any appropriate type of token, such as JWT and X509 certificate, etc.

As an example, taking the first workload as a Bot, the second workload as a target video application, and using OIDC as a workload identity token distribution framework to issue a first identity token to the Bot and issue an identity token for the second workload based on the SPIFFE framework, first identity assertion information associated with the first identity token includes a “sub” field, and the “sub” field is configured to define identity subject information. Specifically, the “sub” field corresponding to the first identity assertion information is:

```
JSON
{
  “sub”: “acct:${ x _account}/ws:${ x _workspace}/bot:${bot_id}”,
  //Other OIDC built-in fields
}
```

In the second identity token determined based on the first identity assertion information, the “sub” field in the corresponding second identity assertion information may be:

JSON
{
“sub”:
“spiffe://${trust_domain}/acct:${ x _account}/ws:${ x _workspace}/bot:${bot_id}”
}

At block 230, the token exchange module 130 sends the second identity token to the first workload, to enable the first workload to call the second workload based on the second identity token.

In some embodiments, the token exchange module 130 may send the second identity token to the first workload via a token exchange endpoint associated with the first trust domain.

Since the second identity token is generated based on the second authentication protocol and is trusted in the second trust domain, the first workload can call the second workload based on the second identity token.

FIG. 3 shows a flow chart of a request calling process according to some embodiments of the present disclosure, and a description will now be given with reference to FIG. 3.

Taking FIG. 3 as an example, the first trust domain is associated with the first workload 110, i.e., OIDC service. The OIDC service can provide OIDC identity distribution, identity assertion token authentication capability, federation management capability, etc. Specifically, the OIDC service may include an OIDC identity distribution component 310, an OIDC federation management service 320, and an OIDC JSON Web Key SET (JWKS) endpoint 330, etc. The second trust domain is associated with the second workload 120, i.e., OIDC token exchange service (token exchange module 130). The OIDC token exchange service is configured to provide the verification capability of OIDC tokens, and can issue identity assertion information with equal identity validity within this trust domain. Specifically, the OIDC token exchange service may include an OIDC token exchange endpoint, a trust anchor configurator, and an issuer, etc. The trust anchor configurator in the second trust domain is configured with JWKS endpoint address (second address information), root certificate, identity authentication information, etc. associated with the first trust domain, in which the identity authentication information may include a predetermined identity assertion field.

In some embodiments, the OIDC identity distribution component 310 in the first trust domain distributes the first identity token to the first workload 110, in which the first workload 110 cannot call the second workload 120 based on the first identity token. It should be noted that in addition to distributing identity tokens to workloads in the first trust domain, the OIDC identity distribution component can also be responsible for the turnaround of identity assertion information, etc.

In some embodiments, the first workload 110 requests the OIDC federation management service 320 (identity management service) to obtain a token exchange endpoint address corresponding to the second trust domain, in which the token exchange endpoint address is associated with the first trust domain.

In some embodiments, the first workload 110 sends the first identity token to an OIDC token exchange endpoint 340 corresponding to the token exchange endpoint address based on the token exchange endpoint address, so that the OIDC token exchange endpoint 340 can receive the first identity token.

In some embodiments, the OIDC token exchange service obtains a domain name corresponding to the OIDC JWKS endpoint 330 from a trust anchor configurator 360, and determines the OIDC JWKS endpoint 330 associated with the first trust domain based on the domain name corresponding to the OIDC JWKS endpoint 330.

In some embodiments, the OIDC token exchange service sends a key obtaining request to the OIDC JWKS endpoint 330 to obtain the target key.

In some embodiments, in addition to obtaining the target key, the OIDC token exchange service may also obtain a certificate chain issued by the OIDC JWKS endpoint 330. The OIDC token exchange service may obtain the root certificate from the trust anchor configurator 360. The OIDC token exchange service may authenticate the certificate chain based on the root certificate, and determine whether the target key is secure based on whether the authentication is passed.

In some embodiments, in response to determining that the target key is secure, the OIDC token exchange service may decrypt the first identity token based on the target key to obtain the identity assertion information in the first identity token.

In some embodiments, an issuer 350 calls a credential issuance interface (identity issuance interface) to issue a corresponding identity credential, that is, calls an identity distribution framework 370, generates the second identity token based on the decrypted identity assertion information, and returns the second identity token from the OIDC token exchange endpoint 340 to the first workload 110.

The first workload 110 calls the second workload 120 via the second identity token. The second workload 120 calls the identity issuance framework 370 in the second trust domain to authenticate the second identity token. After completing identity authentication and authorization, a call result is returned to the first workload 110.

In the embodiments of the present disclosure, a first identity token generated based on a first authentication protocol can be converted into a second identity token that is trusted by a second trust domain, so as to support a first workload in the first trust domain to call a second workload in the second trust domain based on the second identity token. In this way, the embodiments of the present disclosure can implement cross-protocol identity authentication, thereby supporting request calls across trust domains.

### Example Apparatuses and Devices

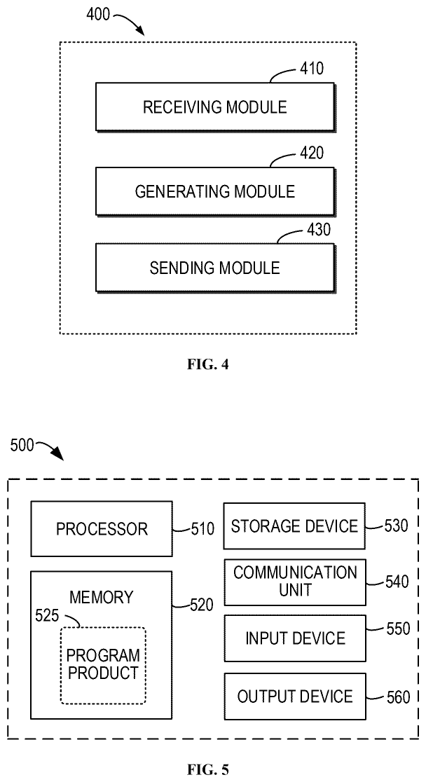

Embodiments of the present disclosure also provide corresponding apparatuses for implementing the above methods or processes. FIG. 4 shows a schematic structural block diagram of an apparatus 400 for request processing according to certain embodiments of the present disclosure. The apparatus 400 may be implemented as or included in an electronic device 110 as discussed above. Each module/component in the apparatus 400 may be implemented by hardware, software, firmware, or any combination thereof.

As shown in FIG. 4, the apparatus 400 includes a receiving module 410 configured to receive a first identity token associated with a first workload in response to a request by the first workload to call a second workload, in which the first workload is associated with a first trust domain, the first identity token is generated based on a first authentication protocol corresponding to the first trust domain, and the second workload is associated with a second trust domain; a generating module 420 configured to generate a second identity token corresponding to a second authentication protocol based on identity assertion information indicated by the first identity token, in which the second authentication protocol corresponds to the second trust domain; and a sending module 430 configured to send the second identity token to the first workload, to enable the first workload to call the second workload based on the second identity token.

In some embodiments, the receiving module 410 is further configured to receive, via a token exchange endpoint associated with the first trust domain, the first identity token associated with the first workload.

In some embodiments, the first workload is configured to obtain first address information of the token exchange endpoint from an identity management service associated with the first trust domain to send the first identity token to the token exchange endpoint.

In some embodiments, the generating module 420 is further configured to: determine a target field for identity assertion based on the first identity token; determine whether the target field matches an identity authentication field maintained by the second trust domain; and in response to the target field matching the identity authentication field, generate the second identity token corresponding to the second authentication protocol based on the identity assertion information.

In some embodiments, the generating module 420 is further configured to: obtain a target key corresponding to the first trust domain; and decrypt the first identity token with the target key to determine the identity assertion information.

In some embodiments, the generating module 420 is further configured to: determine second address information of a key obtaining endpoint associated with the first trust domain based on configuration information associated with the second trust domain; and obtain the target key corresponding to the first trust domain from the key obtaining endpoint based on the second address information.

In some embodiments, the generating module 420 is further configured to: obtain a certificate chain issued by the target endpoint, in which the certificate chain includes at least one certificate other than a root certificate; determine the root certificate based on the configuration information associated with the second trust domain; authenticate the certificate chain based on the root certificate to determine whether the authentication of the target key is passed; and in response to the authentication of the target key being passed, decrypt the first identity token based on the target key.

In some embodiments, the generating module 420 is further configured to: process the identity assertion information by calling an identity issuance interface corresponding to the second authentication protocol, and generate the second identity token corresponding to the second authentication protocol.

In some embodiments, the first trust domain is associated with an application development platform, and the first workload is associated with an application developed in the application development platform.

In some embodiments, the first authentication protocol is implemented based on the OAuth protocol.

The units and/or modules included in the apparatus 400 may be implemented in a variety of ways, including software, hardware, firmware, or any combination thereof. In some embodiments, one or more units and/or modules may be implemented by using software and/or firmware, such as machine-executable instructions stored on a storage medium. In addition to or as an alternative to machine-executable instructions, some or all of the units and/or modules in the apparatus 400 may be implemented at least in part by one or more hardware logic components. By way of example and without limitation, exemplary types of hardware logic components that may be used include field programmable gate arrays (FPGAs), application specific integrated circuits (ASICs), application specific standard products (ASSPs), systems on chips (SOCs), and complex programmable logic devices (CPLDs), and the like.

FIG. 5 shows a block diagram of an electronic device 500 capable of implementing one or more embodiments of the present disclosure. It should be understood that the electronic device 500 shown in FIG. 5 is merely exemplary and should not constitute any limitation on the functions and scope of the embodiments described herein. The electronic device 500 shown in FIG. 5 may be used to implement the electronic device 110 shown in FIG. 1.

As shown in FIG. 5, the electronic device 500 is in the form of a general-purpose computing device. Components of the electronic device 500 may include, but are not limited to, one or more processors or processing units 510, a memory 520, a storage apparatus 530, one or more communication units 540, one or more input apparatuses 550, and one or more output apparatuses 560. The processor 510 may be an actual or virtual processor and can execute various processing according to programs stored in the memory 520. In a multiprocessor system, multiple processing units execute computer-executable instructions in parallel to improve a parallel processing capability of the electronic device 500.

The electronic device 500 typically includes multiple computer storage mediums. Such mediums may be any available mediums accessible by the electronic device 500, and include but are not limited to volatile and nonvolatile mediums, and removable and non-removable mediums. The memory 520 may be a volatile memory (such as a register, a cache and a random access memory (RAM)), a nonvolatile memory (such as a read-only memory (ROM), an electrically erasable programmable read-only memory (EEPROM) and a flash memory) or some combinations thereof. The storage apparatus 530 may be a removable or non-removable medium and may include a machine-readable medium, such as a flash drive, a magnetic disk or any other mediums, which can be used to store information and/or data (such as training data for training) and may be accessed within the electronic device 500.

The electronic device 500 may further include additional removable/non-removable, volatile/nonvolatile storage mediums. Although not shown in FIG. 5, a disk drive for reading from or writing into a removable and nonvolatile magnetic disk (such as a “floppy disk”) and an optical disk drive for reading from or writing into a removable and nonvolatile optical disk may be provided. In these cases, each drive may be connected to a bus (not shown) by one or more data medium interfaces. The memory 520 may include a computer program product 525 having one or more program modules configured to execute various methods or actions according to various embodiments of the present disclosure.

The communication unit 540 realizes communication with other computing devices through a communication medium. Additionally, functions of the components of the electronic device 500 may be realized in a single computing cluster or a plurality of computing machines, and these computing machines can communicate through communication connections. Therefore, the electronic device 500 can operate in a networked environment by using logical connections with one or more other servers, a network personal computer (PC) or another network node.

The input apparatus 550 may be one or more input devices, such as a mouse, a keyboard and a trackball. The output apparatus 560 may be one or more output devices, such as a display, a speaker and a printer. The electronic device 500 may also communicate with one or more external devices (not shown), such as storage devices and display devices, through the communication unit 540 as needed, communicate with one or more devices that enable users to interact with the electronic device 500, or communicate with any devices (such as network cards and modems) that enable the electronic device 500 to communicate with one or more other computing devices. Such communication may be executed via an input/output (I/O) interface (not shown).

According to an exemplary embodiment of the present disclosure, a computer-readable storage medium is provided and has computer-executable instructions stored thereon, wherein the computer-executable instructions are executed by a processor to implement the method described above. According to an exemplary embodiment of the present disclosure, a computer program product is also provided, is tangibly stored on a non-transitory computer-readable medium, and includes computer-executable instructions, which are executed by a processor to implement the method described above. According to an exemplary embodiment of the present disclosure, a computer program product is provided and has a computer program stored thereon, which, when executed by a processor, implements the method described above.

Various aspects of the present disclosure are described herein with reference to the flowcharts and/or block diagrams of the method, apparatus, device and computer program product implemented according to the present disclosure. It should be understood that each block of the flowcharts and/or block diagrams and combinations of various blocks in the flowcharts and/or block diagrams may be realized by computer-readable program instructions.

These computer-readable program instructions may be provided to the processing unit of a general-purpose computer, a special-purpose computer or other programmable data processing apparatus to produce a machine, so that these instructions, when executed by the processing unit of the computer or other programmable data processing apparatus, produce the apparatus realizing the functions/actions specified in one or more blocks in the flowcharts and/or block diagrams. These computer-readable program instructions may also be stored in a computer-readable storage medium, and these instructions enable the computer, the programmable data processing apparatus and/or other devices to work in a particular manner, so that the computer-readable medium having the instructions stored includes an article of manufacture including the instructions realizing various aspects of the functions/actions specified in one or more blocks in the flowcharts and/or block diagrams.

The computer-readable program instructions may be loaded onto the computer, other programmable data processing apparatuses, or other devices, such that a series of operation steps are executed on the computer, other programmable data processing apparatuses, or other devices to produce a computer-implemented process. Therefore, the instructions executed on the computer, other programmable data processing apparatuses, or other devices realize the functions/actions specified in one or more blocks in the flowcharts and/or block diagrams.

The flowcharts and block diagrams in the figures show possibly realized architectures, functions and operations of systems, methods and computer program products according to multiple embodiments of the present disclosure. In this regard, each block in the flowcharts or block diagrams may represent a module, a program segment or a part of instruction, and the module, the program segment or the part of instruction contains one or more executable instructions for realizing specified logical functions. In some alternative embodiments, the functions noted in the blocks may also occur in a different order than those noted in the figures. For example, two consecutive blocks may be actually executed substantially in parallel, and sometimes they may be executed in a reverse order, depending on the functions involved. It should also be noted that each block in the block diagrams and/or flowcharts and combinations of the blocks in the block diagrams and/or flowcharts may be realized by a dedicated hardware-based system executing specified functions or actions, or may be realized by a combination of dedicated hardware and computer instructions.

Various embodiments of the present disclosure have been described above, and the above descriptions are exemplary, are not exhaustive, and are not limited to the disclosed various embodiments. Many modifications and changes will be obvious to those ordinary skilled in the art without departing from the scope and spirit of the described various embodiments. The terminology used herein is chosen to best explain principles of various embodiments, practical application or improvement to technologies in the market, or to enable other ordinary skilled in the art to understand various embodiments disclosed herein.

1-14. (canceled)

15. A method of request processing, comprising:
in response to a request to call a second workload by a first workload, receiving a first identity token associated with the first workload, the first workload being associated with a first trust domain, the first identity token being generated based on a first authentication protocol corresponding to the first trust domain, and the second workload being associated with a second trust domain;
generating a second identity token corresponding to a second authentication protocol based on identity assertion information indicated by the first identity token, the second authentication protocol corresponding to the second trust domain; and
sending the second identity token to the first workload, to enable the first workload to call the second workload based on the second identity token.

16. The method according to claim 15, wherein receiving the first identity token associated with the first workload comprises:
receiving the first identity token associated with the first workload via a token exchange endpoint associated with the first trust domain.

17. The method according to claim 16, wherein the first workload is configured to:
obtain first address information of the token exchange endpoint from an identity management service associated with the first trust domain to send the first identity token to the token exchange endpoint.

18. The method according to claim 15, wherein generating the second identity token corresponding to the second authentication protocol based on the identity assertion information indicated by the first identity token comprises:
determining, based on the first identity token, a target field for asserting an identity;
determining whether the target field matches authentication information maintained by the second trust domain; and
in response to the target field matching the authentication information, generating the second identity token corresponding to the second authentication protocol based on the identity assertion information.

19. The method according to claim 18, wherein determining the identity assertion information based on the first identity token comprises:
obtaining a target key corresponding to the first trust domain; and
decrypting the first identity token with the target key to determine the identity assertion information.

20. The method according to claim 19, wherein obtaining the target key corresponding to the first trust domain comprises:
determining second address information of a key obtaining endpoint associated with the first trust domain based on configuration information associated with the second trust domain; and
obtaining the target key corresponding to the first trust domain from the key obtaining endpoint based on the second address information.

21. The method according to claim 19, wherein decrypting the first identity token with the target key comprises:
obtaining a certificate chain issued by a target endpoint, wherein the certificate chain comprises at least one certificate other than a root certificate;
determining the root certificate based on configuration information associated with the second trust domain;
verifying the certificate chain based on the root certificate to determine whether authentication of the target key is passed; and
in response to the authentication of the target key being passed, decrypting the first identity token based on the target key.

22. The method according to claim 15, wherein generating the second identity token corresponding to the second authentication protocol based on the identity assertion information indicated by the first identity token comprises:
processing the identity assertion information by calling an identity issuance interface corresponding to the second authentication protocol to generate the second identity token corresponding to the second authentication protocol.

23. The method according to claim 15, wherein the first trust domain is associated with an application development platform, and the first workload is associated with an application developed in the application development platform.

24. The method according to claim 15, wherein the first authentication protocol is implemented based on an OAuth protocol.

25. An electronic device, comprising:
at least one processor; and
at least one memory coupled to the at least one processor and storing instructions for execution by the at least one processor, and the instructions, when executed by the at least one processor, causing the electronic device to perform a method of request processing, comprising:
in response to a request to call a second workload by a first workload, receiving a first identity token associated with the first workload, the first workload being associated with a first trust domain, the first identity token being generated based on a first authentication protocol corresponding to the first trust domain, and the second workload being associated with a second trust domain;
generating a second identity token corresponding to a second authentication protocol based on identity assertion information indicated by the first identity token, the second authentication protocol corresponding to the second trust domain; and
sending the second identity token to the first workload, to enable the first workload to call the second workload based on the second identity token.

26. The electronic device according to claim 25, wherein receiving the first identity token associated with the first workload comprises:
receiving the first identity token associated with the first workload via a token exchange endpoint associated with the first trust domain.

27. The electronic device according to claim 26, wherein the first workload is configured to:
obtain first address information of the token exchange endpoint from an identity management service associated with the first trust domain to send the first identity token to the token exchange endpoint.

28. The electronic device according to claim 25, wherein generating the second identity token corresponding to the second authentication protocol based on the identity assertion information indicated by the first identity token comprises:
determining, based on the first identity token, a target field for asserting an identity;
determining whether the target field matches authentication information maintained by the second trust domain; and
in response to the target field matching the authentication information, generating the second identity token corresponding to the second authentication protocol based on the identity assertion information.

29. The electronic device according to claim 28, wherein determining the identity assertion information based on the first identity token comprises:
obtaining a target key corresponding to the first trust domain; and
decrypting the first identity token with the target key to determine the identity assertion information.

30. The electronic device according to claim 29, wherein obtaining the target key corresponding to the first trust domain comprises:
determining second address information of a key obtaining endpoint associated with the first trust domain based on configuration information associated with the second trust domain; and
obtaining the target key corresponding to the first trust domain from the key obtaining endpoint based on the second address information.

31. The electronic device according to claim 29, wherein decrypting the first identity token with the target key comprises:
obtaining a certificate chain issued by a target endpoint, wherein the certificate chain comprises at least one certificate other than a root certificate;
determining the root certificate based on configuration information associated with the second trust domain;
verifying the certificate chain based on the root certificate to determine whether authentication of the target key is passed; and
in response to the authentication of the target key being passed, decrypting the first identity token based on the target key.

32. The electronic device according to claim 25, wherein generating the second identity token corresponding to the second authentication protocol based on the identity assertion information indicated by the first identity token comprises:
processing the identity assertion information by calling an identity issuance interface corresponding to the second authentication protocol to generate the second identity token corresponding to the second authentication protocol.

33. The electronic device according to claim 25, wherein the first trust domain is associated with an application development platform, and the first workload is associated with an application developed in the application development platform.

34. A non-transitory computer-readable storage medium having a computer program stored thereon, the computer program, when executed by a processor, implementing a method of request processing, comprising:
in response to a request to call a second workload by a first workload, receiving a first identity token associated with the first workload, the first workload being associated with a first trust domain, the first identity token being generated based on a first authentication protocol corresponding to the first trust domain, and the second workload being associated with a second trust domain;
generating a second identity token corresponding to a second authentication protocol based on identity assertion information indicated by the first identity token, the second authentication protocol corresponding to the second trust domain; and
sending the second identity token to the first workload, to enable the first workload to call the second workload based on the second identity token.
